(19) United States
(12) Patent Application Publication
(10) Pub. No.: US 2014/0107912 A1
(43) Pub. Date: Apr. 17, 2014

(54) FACTOR COST TIME SERIES TO OPTIMIZE DRIVERS AND VEHICLES: METHOD AND APPARATUS

(71) Applicants: Sermet Yucel, Edina, MN (US); Melinda G. Moran, Lakeville, MN (US); Maria G. Paterlini, Edina, MN (US); Jon M. Magnuson, St. Paul, MN (US); Samuel E. Martin, St. Paul, MN (US); William H. Headrick, Maplewood, MN (US)

(72) Inventors: Sermet Yucel, Edina, MN (US); Melinda G. Moran, Lakeville, MN (US); Maria G. Paterlini, Edina, MN (US); Jon M. Magnuson, St. Paul, MN (US); Samuel E. Martin, St. Paul, MN (US); William H. Headrick, Maplewood, MN (US)

(21) Appl. No.: 13/779,923

(22) Filed: Feb. 28, 2013

Related U.S. Application Data
(60) Provisional application No. 61/714,943, filed on Oct. 17, 2012.

(51) Int. Cl. G07C 5/08

(52) U.S. Cl. CPC G07C 5/08
USPC 701/123; 701/1

(57) ABSTRACT

A method and system for analyzing and improving driver and vehicle performance are described. Detailed vehicle data, including high frequency time series data, which was collected during a trip, is obtained, as well as external data regarding trip route and environment. Using the data and a model of the physics of the vehicle, driver and vehicle time series may be obtained for the trip. These time series may allocate fuel consumption to various factor costs relating to the driver (e.g., rate of acceleration, choice of gear) and to the vehicle (e.g., choice of engine, aerodynamic improvements). From trip simulations run with virtual drivers, an optimal (relative to some criterion) virtual driver (i.e., control choices) can be obtained. Simulations with the optimal driver can find an optimal vehicle from a set of virtual vehicles. Losses due to driver behavior and to vehicle configuration can be computed by comparisons, and alternatives suggested.

### CROSS-REFERENCES TO RELATED APPLICATIONS

This application claims the benefit of U.S. Provisional Application No. 61/714,943, filed on Oct. 17, 2012 and entitled “Factor Cost Time Series to Optimize Drivers and Vehicles: Method and Apparatus”, which is incorporated by this reference. This application contains subject matter that is related to the following three U.S. applications, which are all hereby incorporated by reference: U.S. application Ser. No. 13/251,711, filed Oct. 3, 2011, and entitled “Fuel Optimization Display”; U.S. application Ser. No. 13/285,350, filed Oct. 31, 2011, and entitled “Selecting a Vehicle to Optimize Fuel Efficiency for a Given Route and a Given Driver”; and U.S. application Ser. No. 13/285,340, filed Oct. 31, 2011, and entitled “Selecting a Route to Optimize Fuel Efficiency for a Given Vehicle and a Given Driver”.

### FIELD OF THE INVENTION

The present invention relates to analysis of vehicle performance. More specifically, it relates to comparisons of actual vehicle and driver performance factor costs with optimal counterparts inferred from observations, physics, and simulations.

### BACKGROUND OF THE INVENTION

Improving fuel efficiency in heavy-duty vehicles provides numerous benefits to the national and global communities. Heavy-duty vehicles consume a substantial amount of diesel fuel and gasoline, increasing dependence on fossil fuels. In the United States, medium and heavy-duty vehicles constitute the second largest contributor within the transportation sector to oil consumption. “EPA and NHTSA Adopt First-Ever Program to Reduce Greenhouse Gas Emissions and Improve Fuel Efficiency of Medium- and Heavy-Duty Vehicles”, Regulatory Announcement EPA-420-F-11-031, U.S. Environmental Protection Agency, August 2011 (hereinafter, “EPA Fact Sheet”). Currently, heavy-duty vehicles account for 17% of transportation oil use. “Annual Energy Outlook 2010”, U.S. Energy Information Admin., Report DOE/EIA-0382(2010), April 2010. Demand for heavy-duty vehicles is expected to increase 37% between 2008 and 2035 (EPA Fact Sheet), making the need for more fuel-efficient vehicles even more apparent.

Heavy-duty vehicles also emit into the atmosphere carbon dioxide, particulates, and other by-products of burning fossil fuels. The EPA estimates that the transportation sector emitted 29% of all U.S. greenhouse gases in 2007 and has been the fastest growing source of U.S. greenhouse gas emissions since 1990. “Inventory of US Greenhouse Gas Emissions and Sinks: 1990-2009”, Report EPA 430-R-11-005, Apr. 15, 2011. By improving fuel efficiency in heavy-duty vehicles used in the U.S., the amount of greenhouse gases emitted could be drastically reduced. The benefits of improved fuel efficiency have prompted the Obama Administration to implement new regulations mandating stricter fuel efficiency standards for heavy-duty vehicles. In August 2011, the Environmental Protection Agency and the Department of Transportation's National Highway Traffic Safety Administration released the details of the Heavy Duty National Program, designed to reduce greenhouse gas emissions and improve fuel efficiency of heavy-duty trucks and buses. The Program will set forth requirements for fuel efficiency and emissions from heavy-duty vehicles between 2014 and 2018 in a first phase, and from 2018 and beyond in a second phase. The key initiatives targeted by this program are to reduce fuel consumption and thereby improve energy security, increase fuel savings, and reduce greenhouse gas emissions (EPA Fact Sheet). Creating sustainable processes for improving fuel efficiency of heavy-duty vehicles would allow vehicle owners to comply with the new emission standards, and would further the initiatives of the Heavy Duty National Program.

Poor fuel economy consumes resources that a vehicle operator might more profitably spend on opportunities that also benefit the economy as a whole. The EPA and Department of Transportation have estimated that the Heavy Duty National Program would result in savings of $35 billion in net benefits to truckers, or $41 billion total when societal benefits, such as reduced health care costs because of improved air quality, are taken into account. EPA Fact Sheet.

The Fuel Economy Digest (2008) of the American Truck Association lists causes of excessive fuel consumption. There can be as much as 35% variation between drivers. Better route selection can result in 165% improvements in miles per gallon. Tires with poor rolling resistance can reduce mileage by 14%; poor vehicle aerodynamics, 15%. Mismatch between power train and operational requirement for a route consumes 25% more fuel.

### SUMMARY OF THE INVENTION

A method and system for analyzing and improving driver and vehicle (e.g., car, truck, or van) performance are described. The concepts described herein apply to noncommercial vehicles, such as cars, vans, SUVs, and small trucks, as well as to commercial vehicles. Detailed vehicle data, including high frequency time series data, that was collected during a trip, is obtained, as well as external data regarding trip route environment. Using the data and a model of the physics of the vehicle, driver and vehicle time series may be calculated by an analytics system for the trip. These time series may allocate, along a trip route taken by a driver, fuel consumption to various factor costs relating to the driver (e.g., rate of acceleration, choice of gear) and to the vehicle (e.g., choice of engine, aerodynamic improvements). From trip simulations run with virtual drivers, an optimal (relative to some criterion) virtual driver (i.e., control choices) can be obtained by the factor costs analytics system. Comparison with control choices made by the virtual optimal driver along the route may suggest improved driving techniques for the actual driver. Simulations with the optimal driver can find an optimal vehicle from a set of virtual vehicles. Losses due to driver behavior and to vehicle configuration can be computed by comparisons, and alternatives suggested.

### BRIEF DESCRIPTION OF THE DRAWINGS

FIG. 1 is a schematic drawing depicting flow of energy through a vehicle.

FIG. 2 is a simplified model of vehicle configuration as relevant to energy flow.

FIG. 3 is a schematic diagram illustrating a system for analyzing vehicle and route data using a detailed physical model, and for making recommendations.

FIG. 4 is a flowchart illustrating a process for comparing choices made by an actual driver during a trip with choices made by a simulated optimal driver.

FIG. 5 is a graph illustrating a time series of driver speed over a route obtained from monitoring a vehicle and several time series used in simulations to obtain an optimal virtual driver.

FIG. 6 is a flowchart for a process to find an optimal virtual driver for the route.

FIG. 7 is a schematic diagram illustrating a transition that pertains to some portion of a route used to calculate factor costs for a candidate virtual driver.

FIG. 8 is a schematic diagram illustrating calculation of factor costs for a candidate virtual driver for the entire route.

FIG. 9 is a flowchart illustrating a process for rating performance, by factor cost, for a particular driver over a set of routes.

FIG. 10 is flowchart for finding an optimal virtual vehicle for a route, given an optimal virtual driver.

FIG. 11 is a flowchart for comparing performance of an actual vehicle over a route with an optimal virtual vehicle.

FIG. 12 is a graph showing time series of fuel usage attributed to various factors.

FIG. 13 illustrates possible improvements that might be recommended to reduce fuel usage, depending upon which factor costs contribute to an excess.

FIG. 14 is a time series plot illustrating differences in fuel consumption over the route between the actual vehicle and an optimal vehicle for an aero resistance factor cost.

FIG. 15 illustrates possible improvements that might be recommended to reduce excess fuel usage due to an aero resistance factor cost.

FIG. 16 is a process that might be used to aggregate excess fuel usage, categorized by factor costs, over a set of vehicles.

FIG. 17 is a bar chart that illustrates performance by factor costs for a particular driver-vehicle combination.

FIG. 18 is a pie chart that illustrates a breakdown of fuel performance by factor costs for a particular driver-vehicle combination.

### DETAILED DESCRIPTION OF EXEMPLARY EMBODIMENTS

This description provides embodiments of the invention intended as exemplary applications. The reader of ordinary skill in the art will realize that the invention has broader scope than the particular examples described here.

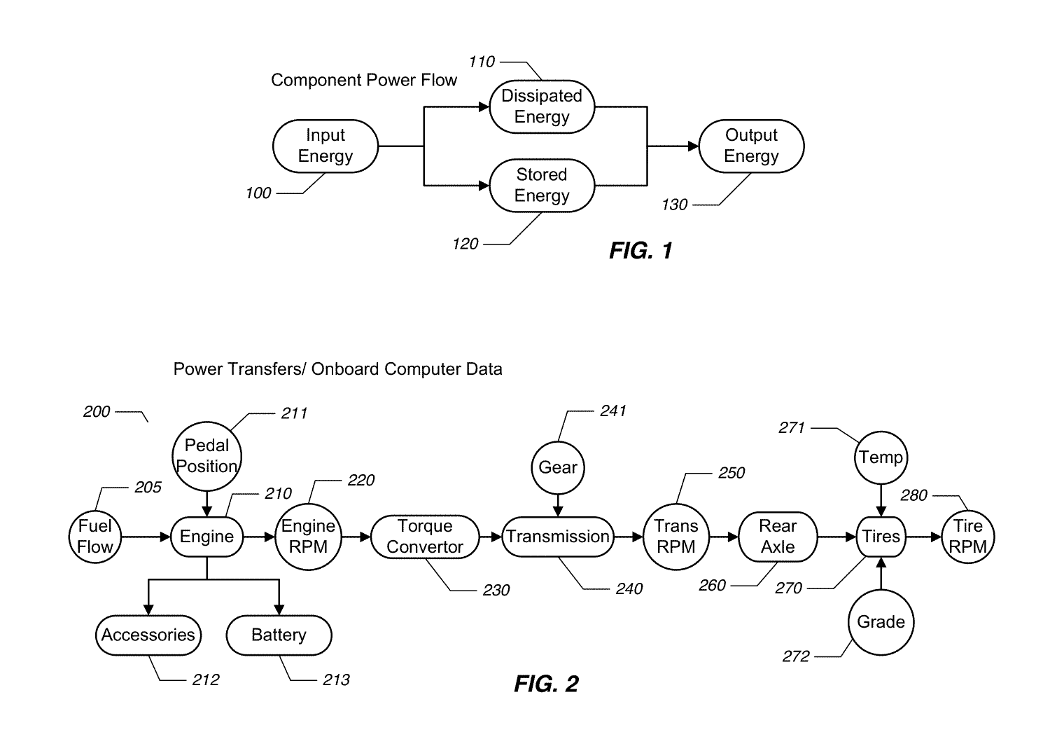

FIG. 1 illustrates the flow of energy through a vehicle. The energy flow is time dependent. At any given time, some of the input energy 100 may be retained as stored energy 120, used for example to charge a battery, or to spin up some component, such as the engine or an axle. Stored energy may later be released as output energy 130 that actually propels the vehicle forward. Some of the input energy 100 will be released unproductively to heat as dissipated energy 110.

FIG. 2 is a high-level depiction of a more detailed vehicle physical model 200 shows how energy flows through components of a vehicle. The gas pedal position 211 chosen by the driver controls fuel flow 205. The fuel is burned by the engine 210. Some of that energy is used to charge the battery 213 and to power accessories 212 such as air conditioning. The remaining energy, in the form of engine RPM 220, is converted by the torque converter 230 for the transmission 240. The behavior of the transmission 240 depends upon the gear 241 chosen by the driver. Output transmission RPM 240 is transmitted to the rear axle 260 upon which the tires 270 are mounted. The tire RPM 280 is affected by environmental factors such as temperature 271 and road properties 272 (for example, grade, roughness, and unevenness). Note that variability in road topography may occur on various scales, possibly affecting vehicle state in different ways. For example, small scale roughness may cause oscillations in the suspension, while equivalent variation in height over larger scales might not.

A much more detailed illustrative vehicle physical model 200 is described in U.S. patent application Ser. No. 13/285,340. As taught by that application and by U.S. patent application Ser. No. 13/285,350, using data that are collected by monitoring by an onboard vehicle system and network, such a model can be used to calculate detailed force and/or torque balances for any major component of the vehicle, and for interaction of the vehicle with the environment (e.g., grade and air resistance). Data from the monitoring and modeling may describe choices of control settings (e.g., gear, gas pedal, brake, accessory use) chosen by the driver so, in effect, the vehicle physical model 200 is also a driver behavior model. The route traveled can be obtained from a geographical positioning system (GPS) location of the vehicle.

Data used in the model may be collected, stored, and/or transmitted at some frequency or frequencies. The sampling interval may be one second or less, or may be longer; the sampling interval may vary over the route. The sampling interval may be based on distance along the route, rather than time. Sampling intervals may vary among the datasets.

Data from sources external to the vehicle may also be used to represent or analyze the route, such as wind data (e.g., from the National Weather Service), precipitation, road grade, traffic controls, and/or traffic conditions and delays. External data may also be used about vehicle components, such as manufacturer specifications regarding engines or tires.

A time series is an ordered sequence of data. The ordering may be by time, by distance 520, or by some other independent variable. The data may or may not be equally spaced in the independent variable. Much of the data, such as gas pedal position 211 and engine RPM 220 collected by monitoring the vehicle can be regarded as time series, where the independent variable is distance 520 along the route followed by the vehicle.

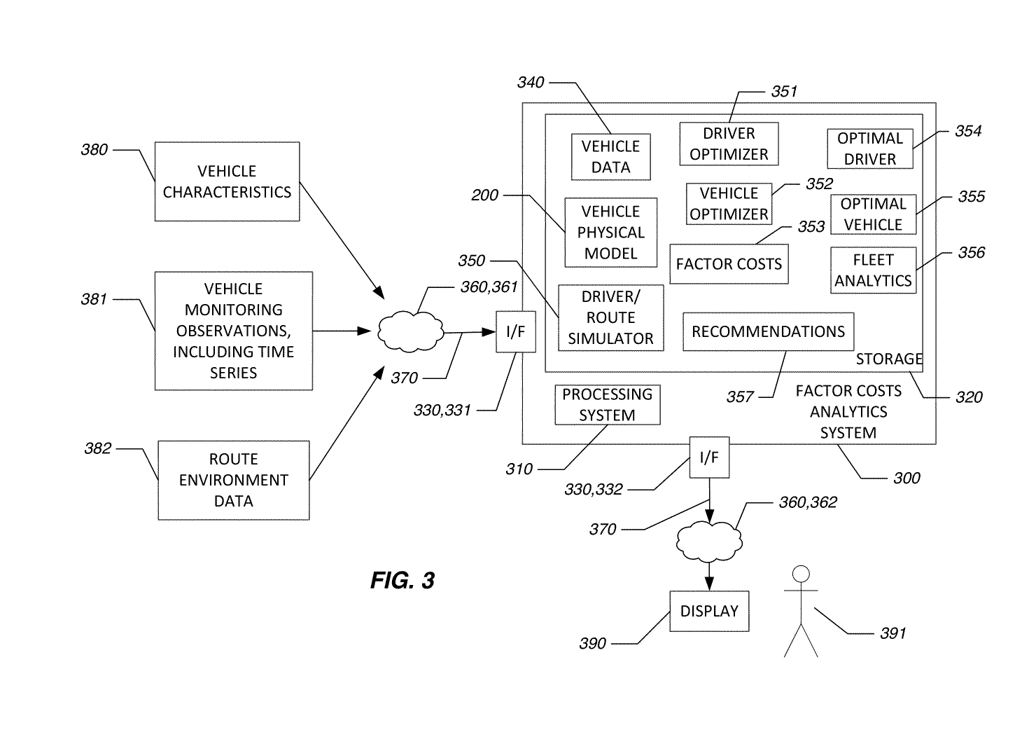

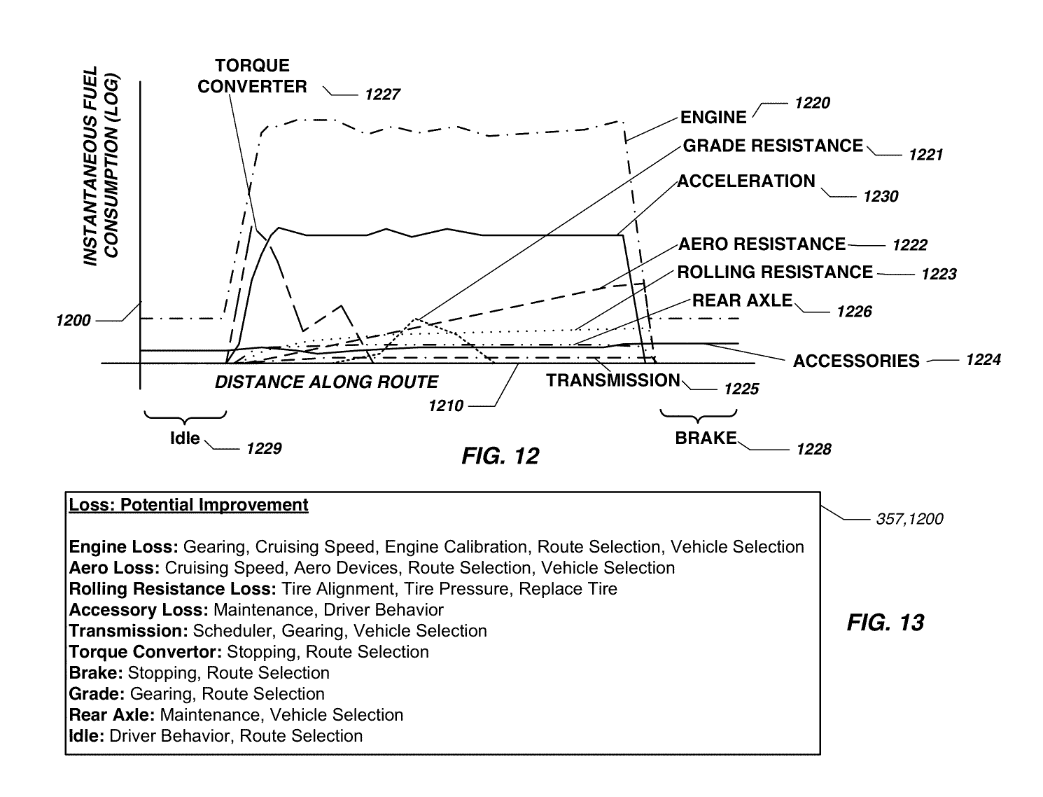

When a driver navigates a particular route, inefficiencies in fuel consumption may be due to configuration of the vehicle—the choice of equipment components and/or maintenance—and to the choices made by the driver in controlling the vehicle. FIG. 3 is a schematic diagram that illustrates a factor costs analytics system (FCAS) 300 that may be used, for example, to distinguish driver choices from vehicle configuration; to analyze both driver and vehicle types of contributions to fuel consumption; to attribute excess fuel consumption to particular driver and vehicles factors; and/or to make recommendations with respect to the driver and/or the vehicle. See FIG. 12 for time series of exemplary factor costs 353.

The FCAS 300 includes data in tangible digital storage, and logic in the form of hardware and/or software instructions. FIG. 3 illustrates a particular configuration or allocation of those components that is not unique. For example, some or all of the logic or data, such as logic of the vehicle physical model 200 may reside and be executed on the vehicle itself. Some or all of the logic or data may reside and/or be processed at a facility external to the vehicle. Also, some FCASs 300 may not include all the components shown.

The illustrated FCAS 300 includes a digital electronic processing system 310, tangible storage 320 (e.g., hard drive(s), optical storage media, and/or memory), and access to one or more external communication systems 360 through interfaces 330. For our purposes, a communication system 360 is hardware and/or software for digital communication. A communication system 360 may be wired or wireless; a communication system 360 may include a network, or be local, or even be internal to a device. A communication system 360 may include two or more connected communication systems 360. For purposes of illustration, FIG. 3 shows two interfaces 330 and 331, through which information is communicated from external sources to the FCAS 300; and 332 through which information is communicated from the FCAS 300 to external recipients. In practice, there may be just one interface 330 through which a FCAS 300 communicates externally, or there may be more than two. Similarly, although the figure shows two communication systems, 361 and 362, both input and output communications may utilize the same communication system 360, or there may be more than two involved.

The illustrated FCAS 300 receives data of various types to perform its analyses. For example, vehicle characteristics 380 may include such information as peak engine horsepower and governed RPM, and gear ratios. A vehicle characteristic 380 may be provided by a manufacturer, or might in some cases be inferred from previous observations taken from the same vehicle or similar ones. As described in U.S. patent applications Ser. Nos. 13/285,340 and 13/285,350, monitoring of the vehicle may provide detailed information about vehicle components and their interactions, driver controls, and route information (e.g., GPS location, and road characteristics 272). Such information may be available at very high frequency, in some cases at intervals of one second or even less. Input of vehicle monitoring observations 381 to the FCAS 300 may include such time series data, possibly as well as static information available from onboard systems about the vehicle. Also, route environment data 382 may be available from third party sources for input to the FCAS 300. Such data might include such information as weather conditions (e.g., wind and temperature data from the U.S. National Climatic Data Center); road conditions, detours, and closings (e.g., from a state department of transportation); and traffic signals.

The storage 320 of the FCAS 300 may include vehicle data 340, such as that just described, and logic and data to represent and execute the vehicle physical model 200. The model and data might be used to provide, for example, details of any energy sources, sinks, and transfers; any torque sources, sinks, and transfers; control positions as chosen by the driver; route taken; and/or environmental conditions affecting the vehicle itself, or the driver's operation of the vehicle. Such data may be available at intervals less than one second, in some cases 0.1 s or shorter, or at longer intervals. The storage 320 may also include, for example, simulator 350 logic and data to simulate a driver navigating a route; driver optimizer 351 logic and data to find an optimal virtual driver 354 for a route; vehicle optimizer 352 logic and data to find an optimal vehicle 355 for a route; and/or factor cost 353 logic and data to allocate costs of operating a vehicle, such as fuel costs, to particular factors of driver choices (e.g, gear selection) and vehicle configuration (e.g, aerodynamic equipment). The storage 320 may also include results from analytics including, for example, control choices and factor costs 353 for one or more optimal drivers 354 for routes; configuration for one or more optimal vehicles 355 for routes; aggregate factor cost 353 allocations, or fleet analytics 356 for fleets (i.e., sets) of vehicles or for teams (i.e., sets) of drivers. The storage 320 may include recommendations 357 that have been deduced from the data and logic. Such data, solutions, and recommendations 357 may be output through an 332 to a system external to the FCAS 300, where it might be provided through a user interface, such as a display 390, for appropriate action by a manager 391 or other actor. Examples of the data, logic, factor costs 353, simulations, optimizations, analyses, and recommendations are presented in more detail below.

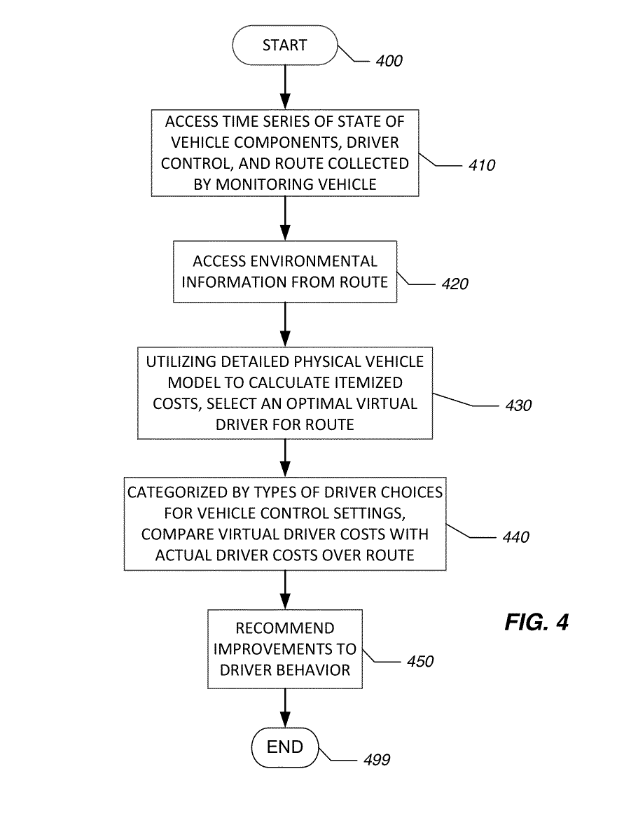

FIG. 4 illustrates a method for simulating the route to find a virtual obtain a “virtual driver” that applies the vehicle controls in an optimal way. The meaning of “optimal” is relative to some measure or “cost”. That “cost” might be total fuel usage, or some combination of fuel usage and time for completing the route, or some other measure. Also, “optimal” is not necessarily best in an absolute sense. When a tool is used to find an extremum (i.e., a maximum or minimum), the tool might not consider all possible cases. For example, the tool may find a relative extremum rather than an absolute extremum. Thus, depending upon the optimization approach, “optimal” may need to be interpreted as best obtainable by the tool/method combination. FIG. 12 illustrates exemplary factor costs 353 that may contribute to a total cost.

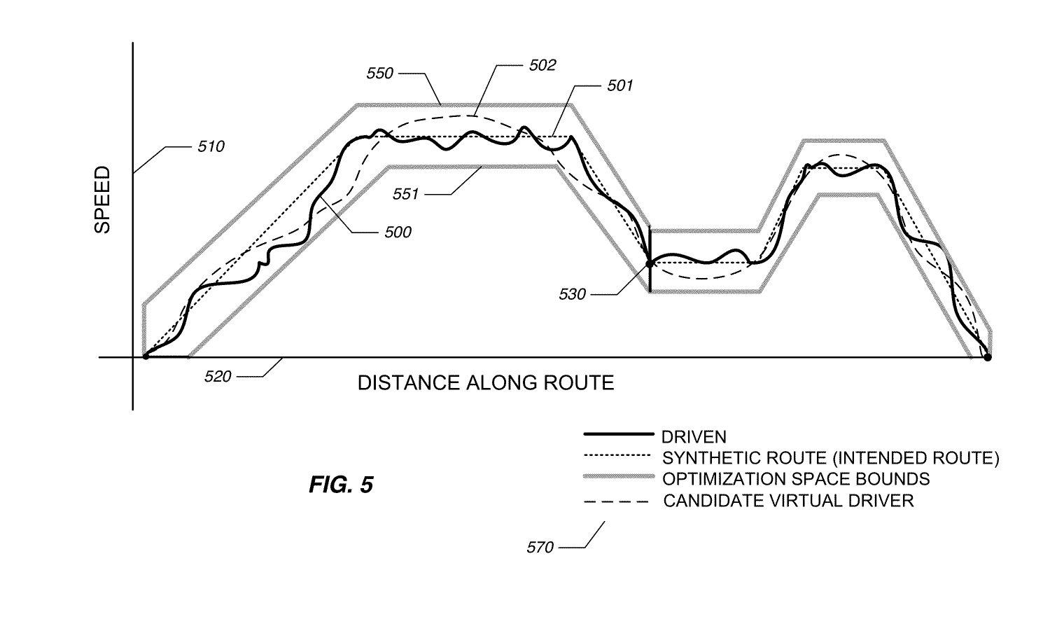

After the start 400 in FIG. 4, various time series are accessed 410, the time series having been collected from the vehicle monitoring over the route. Examples of such time series include energy and torque transfers by vehicle components, the control settings chosen by the actual driver, and route information (e.g., GPS location, grade, and environmental sensors on the vehicle). External environmental data from the route may also be accessed 420. The various data may be accessed, for example, from tangible storage or through an interface to a network. The detailed physical model is utilized 430 to calculate itemized factor costs 353, such as energy used for accessories, that contribute to total cost for the route. Using these itemized factor costs 353, an optimal virtual driver 354 for the route is selected, as illustrated by FIG. 5 through 8. By comparing 440 the usage of vehicle controls during the route of the actual driver with the optimal virtual driver 354, recommendations 357 can be made to change driver behaviors in order to lower cost and improve performance. Such recommendations may be transmitted through a hardware interface 332 by the system that does the processing, such as a display display 390 or an interface to a communication system 362.

FIG. 5 shows one phase of a particular illustrative approach for choosing an optimal virtual driver 354. The vertical axis is speed 510 and the horizontal axis is distance 520 along a route taken by a driver. A legend 570 is provided.

In this illustration, alternative speeds at which a driver could plausibly have driven the route are estimated. From the observed time series 500 of fuel usage, a smoothed time series 501 is constructed. One way of smoothing is to automatically identify the relatively flat portions of the curve, fit those portions with straight flat line segments, and connect them with sloped straight line segments for intervals when the vehicle was accelerating. Alternatively, a low-pass numerical filter (e.g., a moving average, possibly weighted) might be applied (not shown) to smooth the curve. An envelope around the smoothed time series 501, defined by lower bound 551 and upper bound 550, represents a range of plausible speeds at points along the route. A candidate virtual driver is a time series, over the route, of control settings (e.g., accelerator, gear, and brake settings) that satisfy (or nearly satisfy) whatever criteria are set for plausibility or feasibility. In this illustrative method, a candidate driver would stay within (or not depart significantly from) the speed bounds envelope, or optimization space 610, as illustrated by candidate virtual driver time series 502.

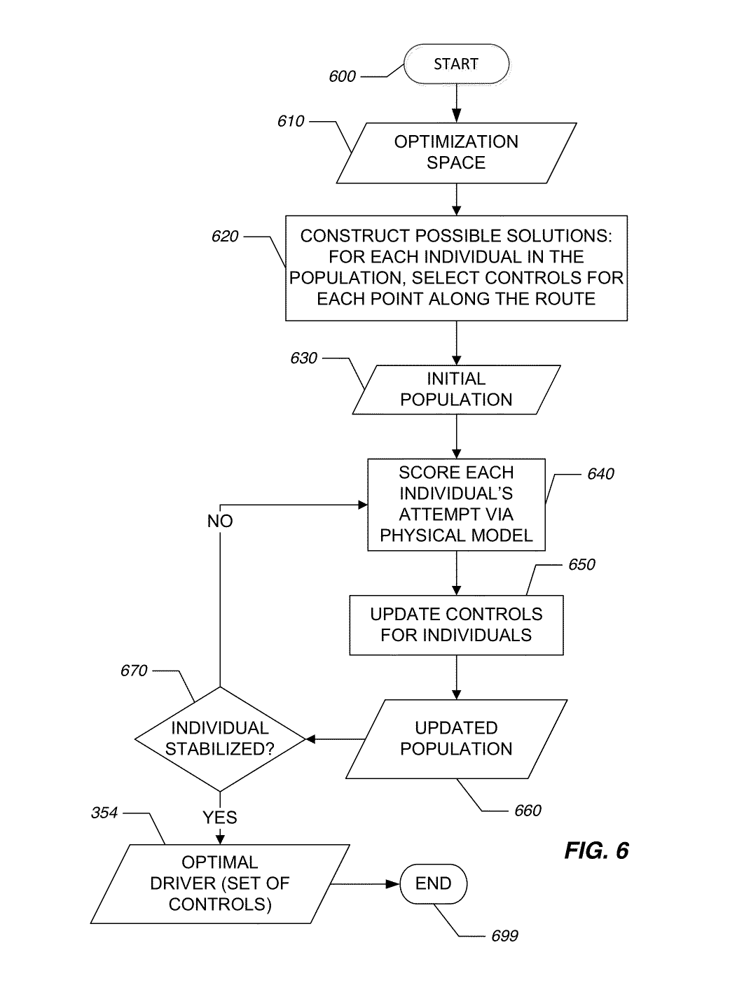

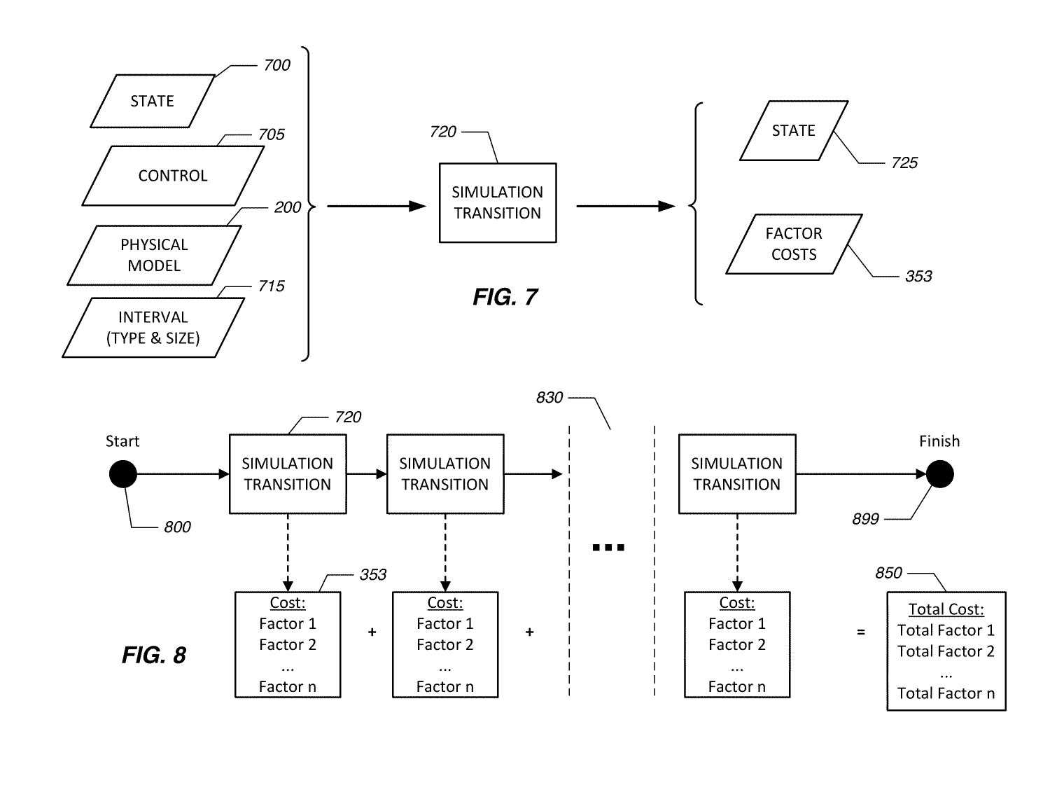

FIG. 6 illustrates an approach to solving for an optimal virtual driver 354, in this case using genetic or swarm optimization. Such optimization techniques are iterative. After the start 600, a set of candidate drivers is selected that conform (or in some implementations, nearly conform) to the optimization space 610. Each virtual driver may represent the control settings for a simulation of the entire route, possibly conducted as in FIGS. 7 and 8. This set is the initial population 630 for the optimization scheme. Each individual in the set is scored 640 using the vehicle physical model 200 to compute costs. See, e.g., FIG. 8. Control settings are updated 650 for some or all individuals, depending on the particular method chosen for advancing the optimization by an iteration step. Methods known to practitioners in the art include “breeding” of pairs of individuals (i.e., somehow combining pairs mathematically), “mutation” of single individuals (typically using some randomization), and/or particle “swarm” optimization (involving sharing of information about strategy among individuals). If 670 the updated population 660 has stabilized, then an optimal driver 354 has been found and the process ends 699. Otherwise, another iteration step is performed.

Of course, many other techniques for finding an optimal driver 354 are possible that might be applied within methods described herein. The mathematical and computer science literature abounds with techniques for minimizing/maximizing functions such as total cost. Note, as mentioned previously, a solution found by a given technique might find only a “relative” extremum, rather than an absolute one. Depending upon implementation, a relative extremum might be satisfactory.

An individual (i.e., a virtual driver) in the simulation may represent a sequence of control transitions 720 to be applied sequentially, thereby advancing the simulated vehicle from along the route. As illustrated by FIG. 7, transition 720 from the current simulation state 700 might occur when the setting of a vehicle control 290 (e.g., gas pedal position, or gear) is changed. The physical model 200 is used to calculate factor costs 353, such as the fuel consumptions shown in FIG. 12, over the duration of the transition 720. A single transition 720 may represent just a short bit of the entire route time series of FIG. 12. After the transition 720, the simulation has a new state 725.

FIG. 8 represents the calculation of costs associated with a single virtual driver (i.e., for a single individual in the population) from start 800 to finish 899 of the simulated route. The factor costs 353 are summed to give factor cost totals 850. The factor cost totals 850 for each individual virtual driver are scores that may be used for comparisons, and hence may influence how the optimization evolves (see 640 of FIG. 6) in the next step.

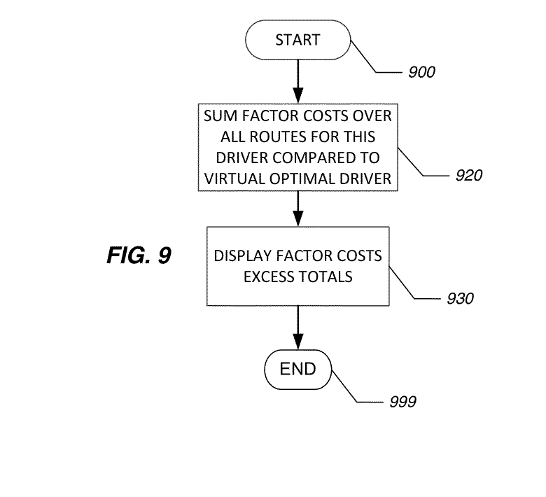

Comparisons between optimal virtual drivers and actual drivers are useful. FIG. 9 illustrates one such use. After the 900, the total excess of factor costs for a particular actual driver over factor costs for virtual driver costs may be computed 920. The resulting values may be displayed 930 through a user interface or transmitted as data. High values for particular factors might suggest corrections to the driver's characteristic choices for operating the vehicle are required. Such analysis might be extended, for example, to the set of drivers for a fleet, suggesting that group training may be warranted.

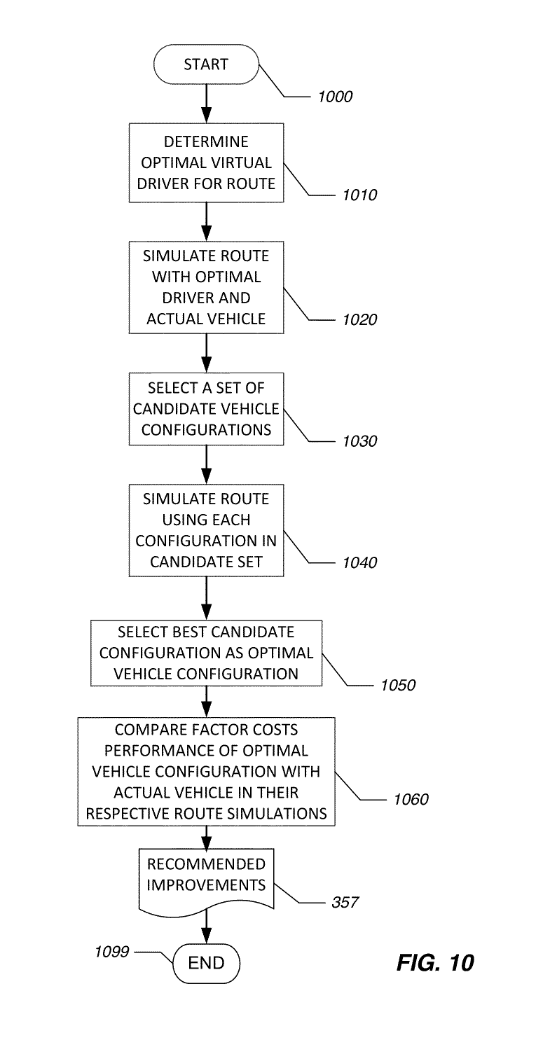

Given the behavior of an optimal virtual driver 354, factor cost 353 comparisons among vehicles may be calculated for a route, as illustrated by FIG. 10. A vehicle being used for a particular route may be compared with alternative vehicles in a fleet. After the 1000 in FIG. 10, an optimal virtual driver 354 for the route is selected 1010, possibly using techniques already described herein. The route is simulated 1020 with the optimal virtual driver 354 and the physical model 200 for an actual vehicle whose performance is being examined. A set of candidate vehicle configurations are chosen 1030 for comparison. A candidate may be, for example, a different vehicle in a fleet, or the same vehicle with some improvement (e.g., different tires). The expected performance of a given vehicle with a virtual driver may be based on, for example, accumulated data about the same vehicle, or a similar vehicle, under similar circumstances; or specifications (e.g., from a manufacturer or vendor) about the effects of installing a new type of component, or repairing/replacing equipment already in place on the vehicle. The route is simulated 1040 with each vehicle in the candidate set to select 1050 an optimal vehicle 355. Comparisons are made 1050 with the actual vehicle. Based on excess factor costs 353, improvements may be recommended 1060, such as using a different vehicle or performing certain maintenance steps on the current one.

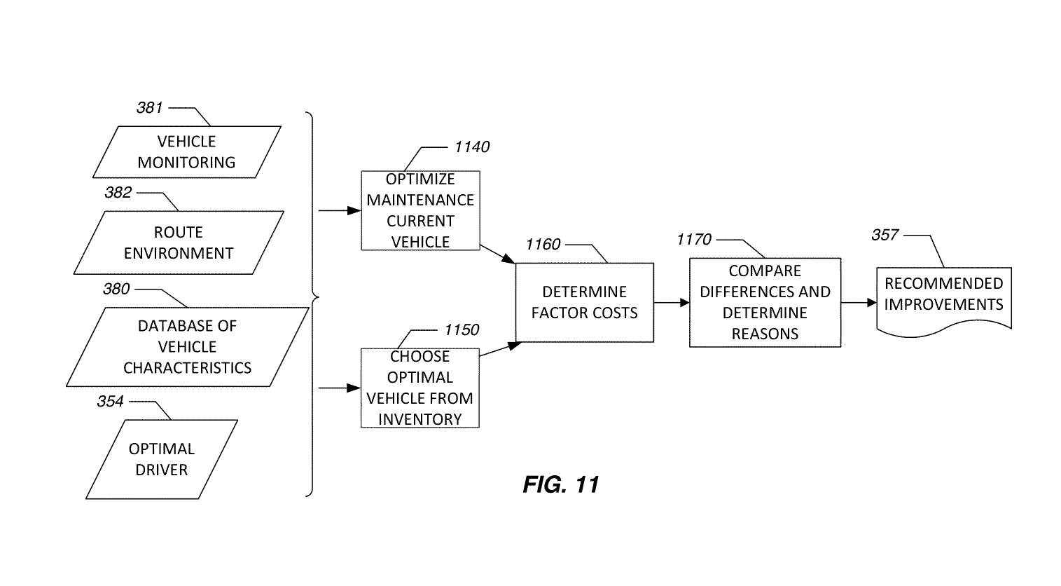

FIG. 11 illustrates a process for choosing between maintenance to a vehicle, which is currently being used for a route, and another vehicle in inventory. Inputs to the process include data from previous vehicle monitoring 381, route environment data 382, vehicle characteristics 380, and the optimal virtual driver 354 for the route. An optimal vehicle 355 is selected 1140 based on maintenance that might be performed on the current vehicle. Another optimal vehicle 355 is chosen 1150 by comparing vehicles already in inventory. Then, factor costs 353 costs are calculated 1160 for each of these two optimal vehicles. Causes for differences in factor costs 353 between the vehicles are determined 1170, and recommendations 357 are made.

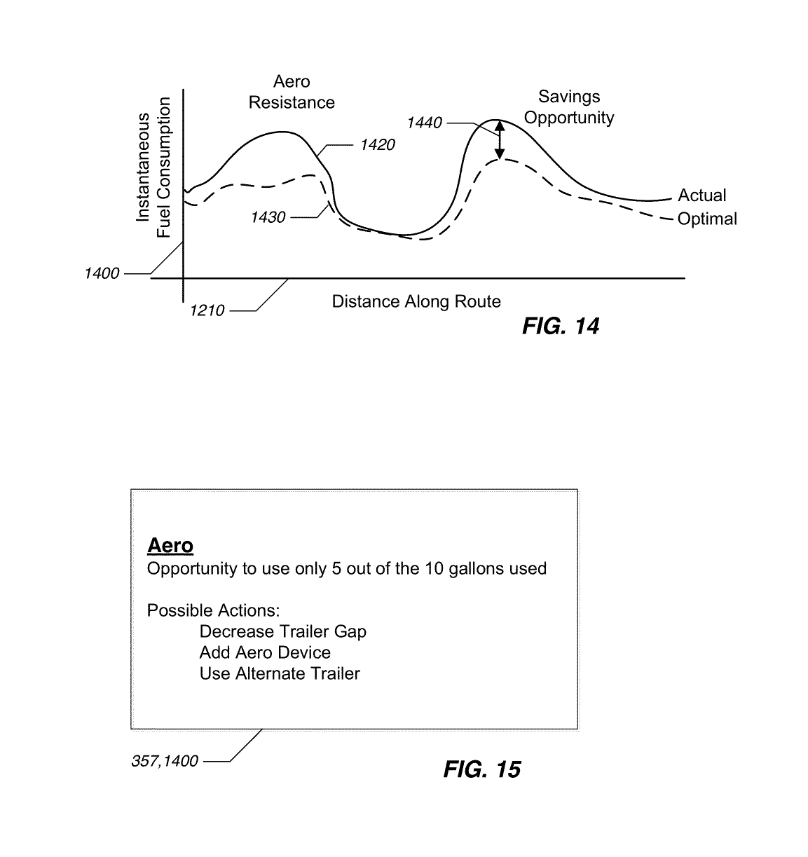

FIG. 12 illustrates fuel consumption, categorized by factor costs 353 over a route, which might be used by an actual driver or for a virtual driver in a simulation. Factors used for analysis may include, for example, ones shown in the figure: engine 1220, grade resistance 1221, aerodynamic resistance 1222, rolling resistance 1223, accessories 1224, transmission 1225, rear axle 1226, brake 1228, idle 1229, and acceleration 1230. Analysis of excess fuel consumption may lead to recommendations for improvement for particular factors, as illustrated by FIG. 13. FIG. 14 illustrates savings opportunity 1440, as a function of distance 520 in (essentially) instantaneous fuel consumption 1200 for one factor cost 353, namely aerodynamic resistance 1222, by using 1430 an optimal virtual driver 354 rather than by using 1420 vehicle. FIG. 15 illustrates recommendations that might be made in response to the results shown in FIG. 12.

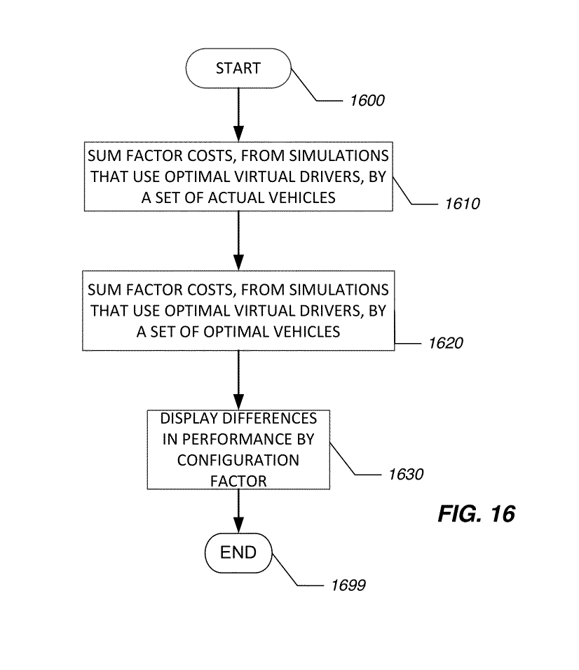

FIG. 16 shows how vehicle optimization might be applied to a set of vehicles, such as a fleet. After the start 1600, factor costs 353, from simulations that use optimal virtual drivers 354, are summed 1610 for the fleet. These costs might be first normalized to a per unit distance basis to facilitate comparisons. A similar sum is computed 1620 for a set of vehicles that are optimized by maintenance, design, or choice for particular routes expected to be traveled. Differences are calculated and displayed 1630, possibly leading to recommendations for improvements. The process ends 1699.

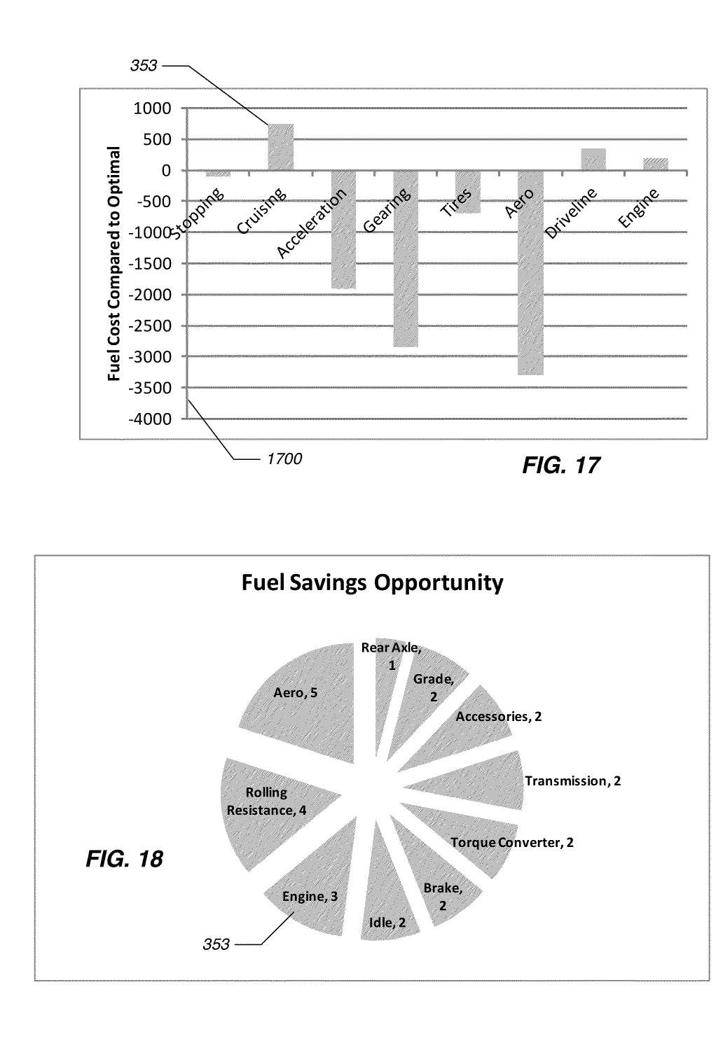

FIG. 17 is a bar chart, illustrating excess factor cost 353 categories. FIG. 18 provides fuel savings opportunities by factor cost 353, with an integer representing the relative size of the savings.

Of course, many variations of the above method are possible within the scope of the invention. The present invention is, therefore, not limited to all the above details, as modifications and variations may be made without departing from the intent or scope of the invention. Consequently, the invention should be limited only by the following claims and equivalent constructions.

What is claimed is:

1. A method, comprising:
a) from tangible storage or through a physical interface, obtaining data that includes
(i) settings of controls of a vehicle at a sequence of points along a road route, and
(ii) estimates of force and/or torque transfers between internal components of the vehicle at the sequence of points along the route;
b) using the data and a model of processes that govern physics of motion of the vehicle, allocating, at the sequence of points, costs of operating the vehicle to a plurality of factor costs, wherein a factor cost can be
(i) a driver factor cost, which corresponds to a category of control setting choices made by the driver along the route, or
(ii) a vehicle factor cost, which corresponds to an aspect of configuration of the vehicle.

2. The method of claim 1, further comprising:
c) estimating at least one of the force and/or torque transfers using the model of processes that govern physics of motion of the vehicle.

3. The method of claim 1, wherein the estimates, of force and/or torque transfers includes an estimate that pertains to a transmission and an estimate that pertains to an engine of the vehicle.

4. The method of claim 1, wherein a given factor cost is estimated at a plurality of points along the route.

5. The method of claim 1, wherein a cost of operating the vehicle at or in a neighborhood a point along the route is allocated among a plurality of factor costs that were each estimated at or in a neighborhood the point.

6. The method of claim 1, wherein a total cost of operating the vehicle over the route is allocated among a plurality of factor costs that were each estimated at a plurality of points along the route.

7. The method of claim 1, further comprising:
c) executing a solution method that seeks a sequence of control settings at points along the route to optimize some criterion relating to cost of operating the vehicle; and
d) using settings of controls indicated by the solution method in part (i) of step a.

8. The method of claim 7, where the solution method is a genetic algorithm or swarm optimization.

9. The method of claim 8, where the solution method includes smoothing speed of the vehicle at points along the route.

10. The method of claim 8, where the solution method utilizes an optimization space that bounds speed of a vehicle at points along the route.

11. The method of claim 1, wherein a factor cost is based, at least in part, upon fuel consumption.

12. The method of claim 1, wherein a factor cost is based, at least in part, upon trip duration.

13. The method of claim 1, wherein a factor cost is based, at least in part, upon wear on the vehicle.

14. A method, comprising:
a) in a simulation executed on a digital processing system, selecting control settings, which represent choices made by a driver of a vehicle, at route points during a road trip;
b) from tangible storage, accessing
(i) a model of the physical processes governing motion of the vehicle during the trip, wherein the model incorporates data obtained by monitoring components of power trains of similarly configured vehicles during actual road trips; and
(ii) data characterizing the power train of the vehicle;
c) using the model and the data, estimating transfers, which relate to vehicle propulsion, between internal components of the vehicle at route points; and
d) based on the estimated transfers,
(i) estimating progress of the vehicle under control of the driver, and
(ii) at route points, allocating costs of operating the vehicle to a plurality of factor costs, wherein a factor cost can be
(i) a driver factor cost, which corresponds to a category of control setting choices made by the driver along the route, or
(ii) a vehicle factor cost, which corresponds to an aspect of configuration of the vehicle.

15. The method of claim 14, further comprising:
e) applying steps a through c to a first virtual driver, the first virtual driver corresponding to a first set of control settings;
f) applying steps a through c to a second virtual driver, the second virtual driver corresponding to a second set of control settings;
g) comparing the driver factor costs of the first virtual driver with the driver factor costs of the second virtual driver.

16. The method of claim 14, further comprising:
e) applying steps a through c to each virtual driver in a first candidate solution set that includes a plurality of virtual drivers, each virtual driver corresponding to a respective set of control settings;
f) based on the results of step d, updating the first candidate solution set to create a second candidate solution set, wherein the second candidate solution set contains a virtual driver that replaces a counterpart in the first candidate solution set; and
g) replacing the first candidate solution set with the second candidate solution set, and repeating steps e and f.

17. The method of claim 16, wherein the replacement driver exhibits a lower driver factor cost than its counterpart.

18. The method of claim 17, further comprising:
h) repeating steps e through g until an optimal virtual driver is converged upon.

19. The method of claim 14, further comprising:
e) selecting an optimal virtual driver using comparisons of respective driver factor costs for a plurality of virtual drivers.

20. The method of claim 19, further comprising:
f) comparing driver factor costs corresponding to a human driver with factor costs corresponding to the optimal virtual driver.

21. The method of claim 20, further comprising:
g) based on the comparison, transmitting through a hardware interface a suggestion for a technique to reduce driver factor costs for the human driver.

22. The method of claim 14, further comprising:
e) using control settings of a given driver and characteristics of a first vehicle, applying steps a through d;
f) using control settings of the given driver and characteristics of a second vehicle, applying steps a through d;
g) comparing the vehicle factor costs of the first vehicle with the vehicle factor costs of the second vehicle.

23. The method of claim 22, wherein the given driver is a virtual driver selected by an optimization process.

24. The method of claim 22, further comprising:
h) based on the comparison, transmitting through a hardware interface a suggestion for a modification to the first vehicle.

25. The method of claim 22, further comprising:
h) based on the comparison, transmitting through a hardware interface a suggestion that the second vehicle be used to drive the route instead of the first vehicle.

26. A system, comprising:
a) tangible digital storage, including
(i) time series data, received from a monitoring system onboard a vehicle, the data including
(A) settings of vehicle controls, as selected by a driver over a route,
(B) status of a plurality of power train components,
(C) rate of fuel consumption,
(D) speed of the vehicle, and
(E) location of the vehicle
(ii) logic that models physical processes of the vehicle;
b) a processing system, including an electronic digital processor, that uses the logic and the data to estimate time series of a set of forces and/or torques acting on a plurality of components internal to the vehicle.

27. The system of claim 26, further comprising:
c) an interface that includes a hardware component, through which the system receives the time series data.

28. The system of claim 26, further comprising:
c) an interface that includes a hardware component, through which the system receives environmental and/or route information.

29. The system of claim 26, further comprising:
c) an interface that includes a hardware component, through which the system transmits information about comparisons of performance factor costs for vehicles and/or drivers.

30. The system of claim 26, further comprising:
c) a database containing attributes of a plurality of vehicle models and/or individuals vehicles; and
d) a database containing road properties along a plurality of routes.
